(19) United States
(12) Patent Application Publication
(10) Pub. No.: US 2025/0258364 A1
(43) Pub. Date: Aug. 14, 2025

(54) OPTICAL SYSTEM AND IMAGE DISPLAY APPARATUS

(71) Applicant: CANON KABUSHIKI KAISHA, Tokyo (JP)

(72) Inventors: Takayuki SUGIYAMA, Tochigi (JP); Masakazu TOHARA, Tokyo (JP)

(21) Appl. No.: 19/047,722

(22) Filed: Feb. 7, 2025

(30) Foreign Application Priority Data
Feb. 14, 2024 (JP) 2024-019913

(51) Int. Cl. G02B 17/08

(52) U.S. Cl. CPC G02B 17/08

(57) ABSTRACT

An optical system is configured to guide light from a display element to an observation side, and includes a transmissive reflective surface, a polarization separation surface, a polarizing element, and a lens including a resin material. The transmissive reflective surface or the polarization separation surface and the polarizing element are integrated with each other to form an optical unit. The optical unit and the lens are cemented to each other via a first adhesive layer. The light transmits through the first adhesive layer a plurality of times. Predetermined inequalities are satisfied.

### BACKGROUND

### Technical Field

The disclosure relates to an optical system suitable for an image display apparatus such as a head mount display (HMD) that displays an enlarged original image displayed on a display element.

### Description of Related Art

As an example of such an optical system, Japanese Patent Laid-Open Nos. 2000-275566 and 2019-148626 disclose an optical system that folds an optical path by using polarization, and includes an optical unit adhered to a lens, in which a polarization selection element (polarization separation element), a half-mirror, a phase plate, a polarizing plate, etc. are laminated.

### SUMMARY

An optical system according to one aspect of the disclosure is configured to guide light from a display element to an observation side, and includes a transmissive reflective surface, a polarization separation surface, a polarizing element, and a lens including a resin material. The transmissive reflective surface or the polarization separation surface and the polarizing element are integrated with each other to form an optical unit. The optical unit and the lens are cemented to each other via a first adhesive layer. The light transmits through the first adhesive layer a plurality of times. The following inequalities are satisfied:

$$0.009 < N 2 \times d 1 < 0.031$$

$$0.95 \leq N 1 / N 2 \leq 1.1$$

where d1 (mm) is a thickness of the first adhesive layer, N1 is a refractive index of the lens for d-line, and N2 is a refractive index of the first adhesive layer for the d-line. An image display apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates the configuration of an image display apparatus having an optical system according to a first embodiment.

FIG. 2 illustrates the configuration of the optical system according to the first embodiment.

FIG. 3 is an optical path diagram of the optical system according to the first embodiment.

FIG. 4 is an enlarged view illustrating the configuration of a cemented portion between an optical unit and a lens in the optical system according to the first embodiment.

FIG. 5 illustrates the configuration of an image display apparatus having an optical system according to a second embodiment.

FIG. 6 illustrates the configuration of the optical system according to the second embodiment.

FIG. 7 is an optical path diagram of the optical system according to the second embodiment.

FIG. 8 is an enlarged view illustrating the configuration of a cemented portion between an optical unit and a lens in the optical system according to the second embodiment.

FIG. 9 illustrates the configuration of an image display apparatus having an optical system according to a third embodiment.

FIG. 10 illustrates the configuration of the optical system according to the third embodiment.

FIG. 11 is an optical path diagram of the optical system according to the third embodiment.

FIG. 12 is an enlarged view illustrating the configuration of a cemented portion between an optical unit and a lens in the optical system according to the third embodiment.

FIG. 13 is an enlarged view illustrating the configuration of a PBS and a cemented portion between a phase plate and a lens in the optical system according to the third embodiment.

FIG. 14 is an external view of the image display apparatus according to FIG. 1.

### DETAILED DESCRIPTION

Referring now to the accompanying drawings, a description will be given of embodiments according to the disclosure.

### First Embodiment

### Image Display Apparatus

FIG. 1 illustrates a head mount display (HMD) 101 as an image display apparatus using an optical system (display optical system, observation optical system, eyepiece optical system) according to a first embodiment, viewed from above. Reference numeral 102 denotes a right eye of an observer (observer's right eye), and reference numeral 103 denotes a left eye of the observer (observer's left eye). Lenses 104 to 106 constitute a part of the right-eye optical system, and lenses 107 to 109 constitute a part of the left-eye optical system. Reference numeral 110 denotes a right-eye display element, and reference numeral 111 denotes a left-eye display element, each of which is constituted by an organic electro-luminescence (EL) element that emits unpolarized light.

The right-eye optical system enlarges light (virtual image) from an original image displayed on the right-eye display element 110 and directs it to the right eye 102, and the left-eye optical system enlarges light from an original image displayed on the left-eye display element 111 and directs it to the left eye 103.

Each of the right-eye optical system and the left-eye optical system has a focal length f of 17 mm, a horizontal display angle of view of 60°, a vertical display angle of view of 60°, and a diagonal display angle of view 2×θ1 of 72°. A distance (eye relief) between the HMD 101 and the observer's eyeball is 12 mm.

### Optical System

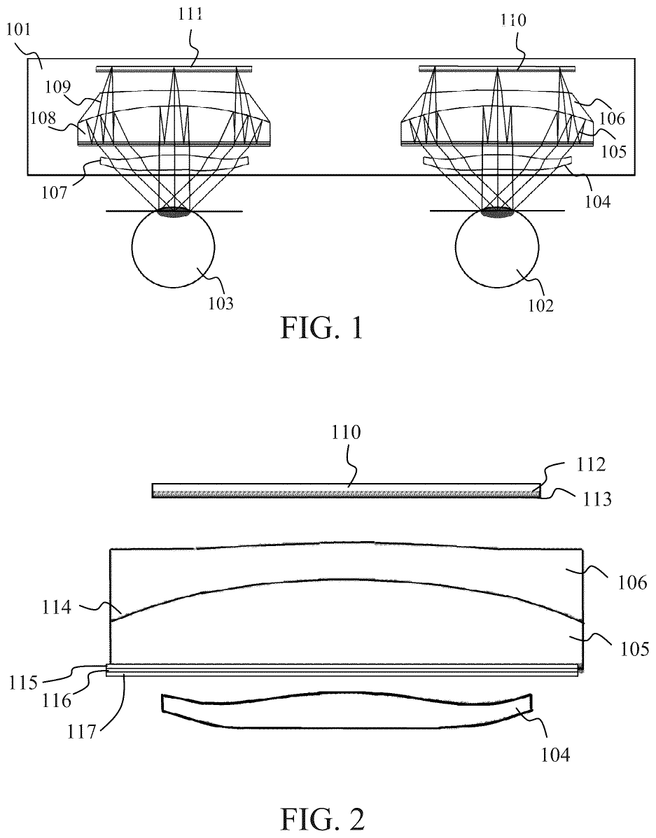

The optical system according to The first embodiment is an optical system that folds the optical path utilizing polarization, and FIG. 2 illustrates an enlarged view of the right-eye optical system. In addition to the lenses 104 to 106, the right-eye optical system further includes a first polarizing plate 112 and a first phase plate 113, arranged in this order from the display element side between the right-eye display element 110 and the first lens 106, and the right-eye optical system further includes a half-mirror 114 evaporated on a display-element-side surface of the second lens 105. Each of the first polarizing plate 112 and the first phase plate 113 has a planar shape, and they are laminated and adhered to the right-eye display element 110. The half-mirror 114 functions as a transmissive reflective surface disposed between cemented surfaces of the first lens 106 and the second lens 105. That is, the first lens 106 and the second lens 105 are configured as a cemented lens in which the half-mirror 114 is sandwiched between the cemented surfaces. The ratio of the transmittance and reflectance of the half-mirror 114 may be 50:50, but the ratio may be changed, as necessary.

The right-eye optical system includes, in order from the display element side between the second lens 105 and the third lens 104, a second phase plate 115, a polarization separation element (polarization beam splitter: PBS) 116, and a second polarizing plate 117. Each of the second phase plate 115, the PBS 116, and the second polarizing plate 117 has a planar shape, and they are laminated and adhered together to form a laminated optical functional element (referred to as an optical unit hereinafter). The PBS 116 functions as a polarization separation surface.

The first polarizing plate 112, the first phase plate 113, the second phase plate 115, and the second polarizing plate 117 correspond to a plurality of polarizing elements.

Each of the first phase plate 113 and the second phase plate 115 is a waveplate with a phase difference of λ/4 (quarter waveplate). The polarization direction of the polarized light that transmits through the first polarizing plate 112 and the slow axis of the first phase plate 113 are tilted by 45°, and the polarization direction of the polarized light that transmits through the first polarizing plate 112 and the slow axis of the second phase plate 115 are tilted by −45°. The polarization direction of the polarized light that transmits through the first polarizing plate 112 and the polarization direction of the polarized light that transmits through the PBS 116 are orthogonal to each other. The polarization direction of the polarized light that transmits through the second polarizing plate 117 and the polarization direction of the polarized light that transmits through the PBS 116 coincide with each other.

In the right-eye optical system, a third lens 104 is disposed between the optical unit that includes the second phase plate 115, the PBS 116, and the second polarizing plate 117, and the exit pupil where the right eye 102 is disposed.

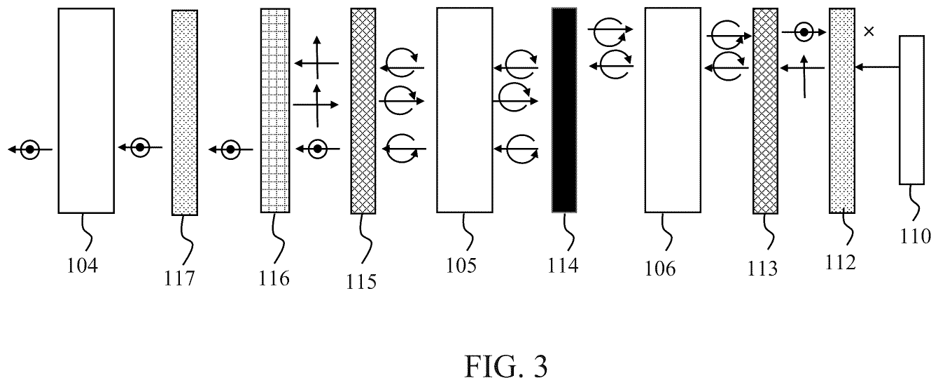

FIG. 3 illustrates the optical path of the right-eye optical system configured as described above. The unpolarized light emitted from the right-eye display element 110 transmits through the first polarizing plate 112 and becomes linearly polarized light, and the linearly polarized light transmits through the first phase plate 113 and becomes circularly polarized light. The circularly polarized light that transmits through the first lens 106 transmits through the half-mirror 114, transmits through the second lens 105 and the second phase plate 115, and becomes linearly polarized light. Since the polarization direction of this linearly polarized light is orthogonal to the transmission polarization direction of the PBS 116, it is reflected by the PBS 116, transmits through the second phase plate 115, and becomes circularly polarized light. The circularly polarized light transmits through the second lens 105, is reflected by the half-mirror 114, transmits through the second lens 105 again, transmits through the second phase plate 115, and becomes linearly polarized light. Since the polarization direction of this linearly polarized light coincides with the transmission polarization direction of the PBS 116, it transmits through the PBS 116, the second polarizing plate 117, and the third lens 104, and is guided to the right eye 102. The second polarizing plate 117 can reduce ghost light caused by external light, and increase the contrast of the displayed image. As for the left-eye optical system, the light from the left-eye display element 111 follows a similar optical path and is guided to the left eye 103.

An optical system that folds the optical path using polarization in this way has a reduced thickness and a reduced focal length, and enables an image to be displayed at a wide angle of view. Forming the first and second lenses 106 and 105 into a cemented lens and further cementing the optical unit to the second lens 105 can further reduce the thickness of the optical system. The third lens 104 disposed in front of the exit pupil can secure high optical performance.

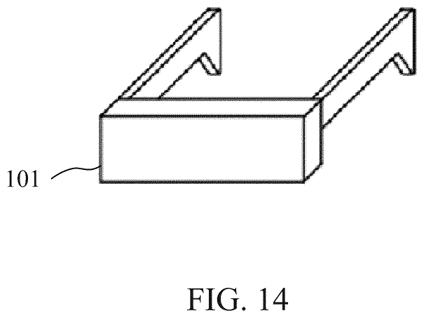

FIG. 14 illustrates the external appearance of the HMD 101. The HMD 101 is mounted on a user's head and thus may have a reduced weight. The lenses constituting the right-eye optical system can be manufactured (formed) using a resin material with a lower specific gravity than that of glass, and all the lenses 104 to 106 are made of resin in the first embodiment. The resin material referred to herein is not limited to a material consisting of resin exclusively, but may contain components other than resin, such as inorganic fine particles, as long as the main component is resin. This is similarly applied to the other embodiments described below.

The second lens 105 as a plano-convex aspherical lens improves the aberration correcting effect. The first lens 106 is also a double-sided aspherical lens. This is similarly applied to the left-eye optical system.

The characteristic configuration of the lenses in this embodiment will be described. The second lens 105 is a lens with positive refractive power, a planar lens surface on the observation side (exit pupil side), and an aspherical lens surface on the display element side (the cemented surface with the first lens 106) that is convex toward the display element side. A half-mirror 114 is provided as a reflective surface on the display-element-side lens surface of the second lens 105, and the half-mirror 114 has positive refractive power, so that the optical path can be folded, and the optical system has a reduced thickness and a wide angle of view. In addition, the display-element-side lens surface of the second lens 105 and the observation-side lens surface of the first lens 106 are cemented together to form a cemented surface, so that the total reflection condition can be avoided for light incident on the cemented surface compared to when these lens surfaces are in contact with air. The first lens 106 is a double-sided aspheric lens with negative refractive power.

The following inequality (1) may be satisfied:

$$0.2 \leq \vert Φ1 / Φ2 \vert \leq 0.8 \qquad ( 1 )$$

where Φ1 is optical power (a reciprocal of a focal length) on the optical axis of the first lens 106, Φ2 is optical power on the optical axis of the second lens 105.

Inequality (1) defines a proper relationship between the optical powers of the first and second lenses 106 and 105 that constitute a cemented lens. In a case where |Φ1/Φ2| becomes higher than the upper limit of inequality (1), the focal length of the optical system increases and the size of the HMD 101 finally increases. In a case where |Φ1/Φ2| becomes lower than the lower limit of inequality (1), it becomes difficult to configure an optical system with good optical performance. In The first embodiment, Φ1=−0.0045, Φ2=0.0085, and |Φ1/Φ2|=0.526. That is, the optical system according to The first embodiment satisfies inequality (1).

The third lens 104 with positive refractive power disposed on the display element side of the exit pupil can correct aberrations that could not be corrected by the first and second lenses 106 and 105. In a case where the third lens 104 is an aspheric lens, higher optical performance can be obtained.

In a case where resin lenses are used for the lenses 104 to 106, birefringence that occurs during molding of each lens may affect the optical performance of the right-eye optical system. Thus, an annealing process or the like may be performed to satisfy the following inequality (2):

$$Re \leq 30 \qquad ( 2 )$$

where Re (nm) is a phase difference amount due to the birefringence of each lens.

In this embodiment, the phase difference amount Re of the first lens 106 is 20 nm, the phase difference amount Re of the second lens 105 is 5 nm, and the phase difference amount Re of the third lens 104 is 20 nm, each of which satisfies inequality (2).

### Adhesive Layer

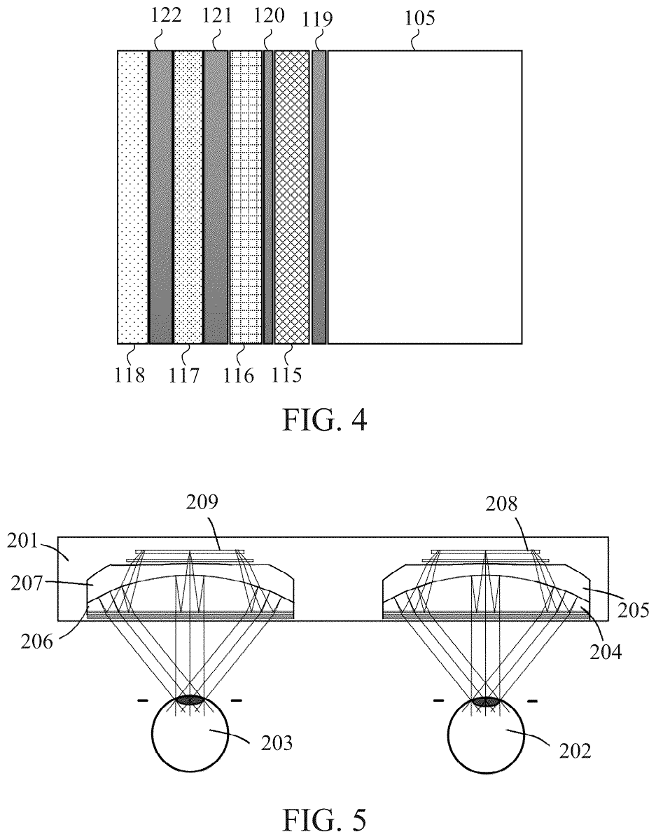

FIG. 4 illustrates an enlarged view of adhesive layers 120 to 122 in the optical unit and an adhesive layer (first adhesive layer) 119 between the optical unit and the lens 105. The second phase plate 115 and the PBS 116 are adhered together via the adhesive layer 120, and the PBS 116 and the second polarizing plate 117 are adhered together via the adhesive layer 121. In order to reduce reflection at the interface between the second polarizing plate 117 and air, an antireflection film 118 is adhered to the second polarizing plate 117 via the adhesive layer 122. The optical unit having such a laminated structure is adhered to the second lens 105 by the adhesive layer 119.

The adhesive layer 119 may satisfy the following inequalities (3) and (4):

$$0.009 < N 2 \times d 1 < 0.031 \qquad ( 3 )$$

$$0.95 \leq N 1 / N 2 \leq 1.1 \qquad ( 4 )$$

where d1 (mm) is a thickness of the adhesive layer 119, N1 is a refractive index of the second lens 105 for the d-line (587.6 nm), and N2 is a refractive index of the adhesive layer 119 for the d-line. The thickness referred to in this specification is the width in the optical axis direction.

Inequality (3) defines a proper range of the optical path length N2×d1 when light transmits through the adhesive layer 119. In a case where N2×d1 becomes higher than the upper limit of inequality (3), the thickness of the adhesive layer 119 increases, and the quality of the displayed image deteriorates due to the influence of birefringence of the adhesive layer 119. In a case where N2×d1 becomes lower than the lower limit of inequality (3), the thickness of the adhesive layer 119 reduces, and the adhesive layer 119 is likely to contain air bubbles due to the influence of surface shape errors of the resin lens and variations in surface shape errors due to the annealing process. As a result, the quality of the displayed image deteriorates.

Inequality (4) defines a proper relationship between the refractive indexes N1 and N2 of the second lens 105 and the adhesive layer 119. Setting N1/N2 within the numerical range of inequality (4) can reduce a refractive index difference between the adhesive layer 119 and the second lens 105, and the influence of the refractive power difference on the optical performance.

In this embodiment, the thickness d1 of the adhesive layer 119 is 0.015 mm (tolerance±0.003 mm), the refractive index N1 of the second lens 105 is 1.54, and the refractive index of the adhesive layer 119 is 1.48. Therefore, N2×d1-0.022 and N1/N2=1.045, and thus inequalities (3) and (4) are satisfied.

d1 may be 0.020 mm or less, 0.019 mm or less, 0.018 mm or less, or 0.016 mm or less. This is also applied to the thickness d1 of the adhesive layer in other embodiments described later.

The thickness d1 of the adhesive layer 119 may satisfy the following inequality (5):

$$0.0002 \leq d 1 / f \leq 0.002 \qquad ( 5 )$$

where f (mm) is a focal length of the optical system.

Inequality (5) defines a proper relationship between the thickness d1 of the adhesive layer 119 and the focal length f of the optical system. Satisfying this condition can reduce the influence of the adhesive layer 119 on the optical performance of the optical system. In this embodiment, the focal length f is 17 mm, and the thickness d1 of the adhesive layer 119 is 0.015 mm, so d1/f=0.0009, which satisfies inequality (5).

In an optical system that folds the optical path utilizing polarization, the adhesive layer 119 significantly affects the optical performance because the light ray from the right-eye display element 110 toward the observation side transmits through the adhesive layer 119 a plurality of times (three times). Therefore, satisfying inequalities (3) to (5) can effectively suppress the deterioration of the quality of the displayed image caused by the cemented portion where the optical unit and the lens 105 are adhered together via the adhesive layer 119.

The adhesive layers 120 to 122 in the optical unit will be described. The following inequality (6) may be satisfied:

$$0.005 mm \leq d 2 < 0.02 mm \qquad ( 6 )$$

where d2 is a thickness of the adhesive layer (second adhesive layer) 120 that adheres the second phase plate 115 and the PBS 116.

Inequality (6) defines a proper range for the thickness d2 of the adhesive layer 120. Since the PBS 116 is a thin film-shape element (referred to as a film element hereinafter), in a case where the adhesive layer 120 has thickness variations (unevenness) in the in-plane direction, unevenness corresponding to that unevenness will also appear on the PBS 116. In a case where the adhesive layer 120 has periodic unevenness, local optical power will be generated for the light reflected by the PBS 116. As a result, the displayed image has a local focus shift, and the displayed image will be observed as a blurred image with reduced contrast. In particular, since the PBS 116 functions as a reflective surface, it is more likely to affect the displayed image than a transparent surface. In a case where d2 becomes higher than the upper limit of inequality (6), the unevenness of the adhesive layer 120 and accordingly the unevenness appearing on the PBS 116 increase, and the optical power for the light reflected by the PBS 116 increases. In a case where d2 becomes lower than the lower limit of inequality (6), the thickness of the adhesive layer 120 reduces, it becomes difficult to adhere the second phase plate 115 and the PBS 116, and wrinkles and air bubbles are more likely to occur in the adhesive layer 120.

In this embodiment, the thickness d2 of the adhesive layer 120 is 0.010 mm (±0.003 mm), which satisfies inequality (6).

d2 may be 0.019 mm or less, 0.018 mm or less, or 0.016 mm or less. This is similarly applied to the thickness d2 of the adhesive layer in the other embodiments described below.

In this embodiment, the thickness of the adhesive layer 121 that adheres the PBS 116 and the second polarizing plate 117 is 0.025 mm (±0.003 mm), and the thickness of the adhesive layer 122 that adheres the second polarizing plate 117 and the antireflection film 118 is 0.025 mm (±0.003 mm). Thereby, the influence of the unevenness of each adhesive layer on the optical performance can be suppressed.

### Second Embodiment

### Image Display Apparatus

FIG. 5 illustrates an HMD 201 as an image display apparatus using an optical system according to a second embodiment, viewed from above. Reference numeral 202 denotes the observer's right eye, and reference numeral 203 denotes the observer's left eye. Lenses 204 and 205 form part of the right-eye optical system, and lenses 206 and 207 form part of the left-eye optical system. Reference numeral 208 denotes a right-eye display element, and reference numeral 209 denotes a left-eye display element, each of which includes an organic EL element that emits nonpolarized light.

The right-eye optical system enlarges the light (virtual image) from the original image displayed on the right-eye display element 208 and guides it to the right eye 202, and the left-eye optical system enlarges the light from the original image displayed on the left-eye display element 209 and guides it to the left eye 203.

Each of the right-eye optical system and the left-eye optical system has a focal length f of 17 mm, a horizontal display angle of view of 60°, a vertical display angle of view of 60°, and a diagonal display angle of view 2×θ1 of 78°. A distance between the HMD 201 and the observer's eyeball (eye relief) is 18 mm.

### Optical System

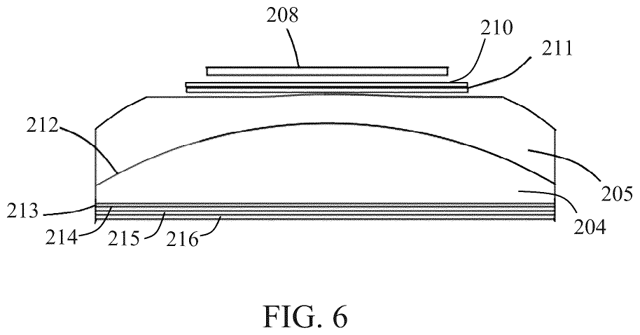

The optical system according to the second embodiment is also an optical system that folds the optical path by utilizing polarization, and an enlarged view of the right-eye optical system is illustrated in FIG. 6. In addition to the lenses 204 and 205, the right-eye optical system further includes a first polarizing plate 210 and a first phase plate 211, arranged in this order from the display element side between the right-eye display element 208 and the first lens 205, and the right-eye optical system further includes a half-mirror 212 evaporated on a display-element-side surface of the second lens 204. Each of the first polarizing plate 210 and the first phase plate 211 has a planar shape, and they are laminated. The half-mirror 212 functions as a transmissive reflective surface disposed between cemented surfaces of the first and second lenses 205 and 204. That is, the first and second lenses 205 and 204 are configured as a cemented lens in which the half-mirror 212 is sandwiched between the cemented surfaces. The ratio of the transmittance and reflectance of the half-mirror 212 may be 50:50, but the ratio may be changed, as necessary.

The right-eye optical system includes, in order from the display element side on the observation side of the second lens 204, a second phase plate 213, a PBS 214, and a second polarizing plate 215. Each of the second phase plate 213, the PBS 214, and the second polarizing plate 215 has a planar shape, and they are laminated and adhered together to form an optical unit.

Each of the first phase plate 211 and the second phase plate 213 is a waveplate with a phase difference of λ/4 (quarter waveplate). The polarization direction of the polarized light that transmits through the first polarizing plate 210 and the slow axis of the first phase plate 211 are tilted by 45°, and the polarization direction of the polarized light that transmits through the first polarizing plate 210 and the slow axis of the second phase plate 213 are tilted by −45°. The polarization direction of the polarized light that transmits through the first polarizing plate 210 and the polarization direction of the polarized light that transmits through the PBS 214 are orthogonal to each other. The polarization direction of the polarized light that transmits through the second polarizing plate 215 and the polarization direction of the polarized light that transmits through the PBS 214 coincide with each other.

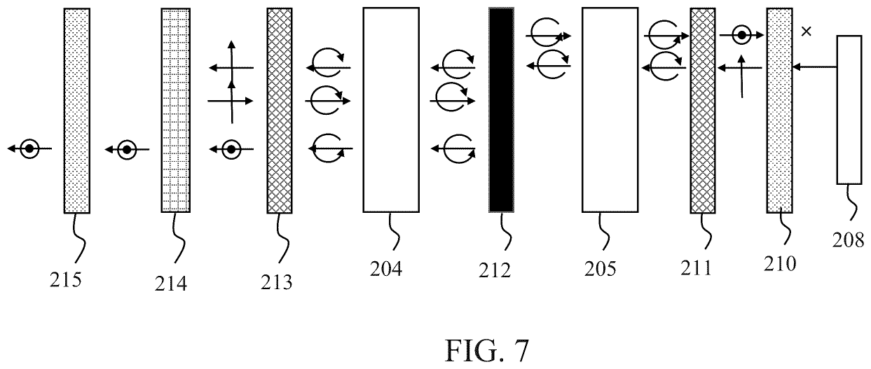

FIG. 7 illustrates the optical path of the right-eye optical system configured as described above. The unpolarized light emitted from the right-eye display element 208 transmits through the first polarizing plate 210 and becomes linearly polarized light, and the linearly polarized light transmits through the first phase plate 211 and becomes circularly polarized light. The circularly polarized light that transmits through the first lens 205 transmits through the half-mirror 212, transmits through the second lens 204 and the second phase plate 213, and becomes linearly polarized light. Since the polarization direction of this linearly polarized light is orthogonal to the transmission polarization direction of the PBS 214, it is reflected by the PBS 214, transmits through the second phase plate 213, and becomes circularly polarized light. The circularly polarized light transmits through the second lens 204, is reflected by the half-mirror 212, transmits through the second lens 204 again, transmits through the second phase plate 213, and becomes linearly polarized light. Since the polarization direction of this linearly polarized light coincides with the transmission polarization direction of the PBS 214, it transmits through the PBS 214 and the second polarizing plate 215, and is guided to the right eye 202. The second polarizing plate 215 can reduce ghost light caused by external light, and increase the contrast of the displayed image. As for the left-eye optical system, the light from the left-eye display element 209 follows a similar optical path and is guided to the left eye 203.

An optical system that folds the optical path utilizing polarization in this way has a reduced thickness and a reduced focal length, and enables an image to be displayed at a wide angle of view. Forming the first and second lenses 205 and 204 into a cemented lens and further cementing the optical unit to the second lens 204 can reduce the thickness of the optical system.

The HMD 201 is mounted on a user's head and thus may have a reduced weight. Thus, the lenses constituting the right-eye optical system can be manufactured using a resin material with a lower specific gravity than that of glass, and all the lenses 204 and 205 are made of resin in the second embodiment. The second lens 204 is also a plano-convex aspherical lens to enhance the aberration correcting effect. The first lens 205 is also a double-sided aspherical lens. This is similarly applied to the left-eye optical system.

The characteristic configuration of the lenses according to this embodiment will be described. The right-eye optical system according to this example includes two lenses 204 and 205. The second lens 204 is a lens with positive refractive power, a flat lens surface on the observation side, and an aspheric lens surface on the display element side (the cemented portion surface with the first lens 205) that is convex toward the display element side. The half-mirror 212 is provided as a reflective surface on the display-element-side lens surface of the second lens 204, and the half-mirror 212 has positive refractive power, so that the optical path can be folded, and the optical system has a reduced thickness and a wide angle of view.

Since the display-element-side lens surface of the second lens 204 and the observation-side lens surface of the first lens 205 are cemented together to form a cemented surface, so that the total reflection condition for light incident on the cemented surface can be avoided compared to when these lens surfaces are in contact with air. The first lens 205 is a double-sided aspheric lens with negative refractive power.

Inequality (1) described in the first embodiment may be satisfied where Φ1 is the optical power on the optical axis of the first lens 205, and Φ2 is the optical power on the optical axis of the second lens 204. In this embodiment, Φ1=−0.0044, Φ2=0.0128, and |Φ1/Φ2|=0.346. In other words, the optical system according to the second embodiment satisfies inequality (1).

The display-element-side surface of the first lens 205 has a convex shape toward the display element side in the central area including the optical axis, but the curvature becomes gentler as it moves away from the optical axis, and has an inflection point within an optically effective area, which is an area through which an effective light ray that contributes to imaging passes. The inflection point is a point where the shape changes from convex to concave toward the display element side. In other words, the inflection point is a point where a value obtained when the curve representing the display-element-side surface of the first lens 205 is differentiated twice becomes 0 in the section along the optical axis of the first lens 205.

The focal length of the optical system is reduced by making the central area including the optical axis of the display-element-side surface of the first lens 205 convex toward the display element side. Making the curvature of the display-element-side surface of the first lens 205 gentler as it moves away from the optical axis can reduce the exit angle from the right-eye display element 208 at the peripheral portion. Such an aspheric shape provided to the display-element-side surface of the first lens 205 can provide an optical system with a reduced focal length and a wide angle of view, reduce the exit angle from the right-eye display element 208 at the peripheral portion, and suppress the deterioration of a field angle characteristic of the display element and a color shift. In addition, this configuration can reduce an incident angle to the first polarizing plate 210 and the first phase plate 211, and thereby suppress factors that deteriorate image quality, such as a light amount decrease, light amount unevenness, and color unevenness.

The aspheric shape on the display element side of the first lens 205 has an inflection point in order to reduce the exit angle from the right-eye display element 208 in the peripheral portion and the focal length of the optical system. The following inequality (7) may be satisfied:

$$0.2 < Yip / Yea < 0.75 \qquad ( 7 )$$

where Yip is a distance from the optical axis to the inflection point, and Yea is a maximum distance (effective diameter) from the optical axis to the optically effective area on the display-element-side surface of the first lens 205.

Inequality (7) defines a proper position of the inflection point on the display-element-side aspheric surface of the first lens 205. In a case where Yip/Yea becomes higher than the upper limit of inequality (7), the inflection point is located at the peripheral portion of the optically effective area, and the effect of reducing the exit angle from the right-eye display element 208 at the peripheral portion is reduced. In a case where Yip/Yea becomes lower than the lower limit of inequality (7), the inflection point is close to the optical axis, and the optical power near the optical axis is reduced, and the focal length of the optical system cannot be reduced.

In this embodiment, Yip is 4 mm, Yea is 12 mm, and Yip/Yea=0.33, and thus inequality (7) is satisfied.

Inequality (7) may be replaced with inequality (7a) below:

$$3 \leq Yip / Yea \leq 0.7 \qquad ( 7 a )$$

The aspheric shape on the display element side of the first lens 205 changes monotonically as it moves away from the optical axis, and has no maximum or minimum values within the optically effective area other than a point on the optical axis. Such an aspheric shape can reduce the exit angle from the right-eye display element 208 at the peripheral portion and the focal length of the optical system. Reducing an aspheric shape change can reduce an optical performance change from the central portion to the peripheral portion, present a display image that is easy to observe, and improve the processing accuracy of the aspheric shape. The above description of the first lens 205 is also applicable to the first lens 207 in the left-eye optical system.

Even in this embodiment, the first and second lenses 205 and 204 are made of resin, and birefringence occurring during molding of each lens may negatively affect the optical performance of the right-eye optical system. Therefore, an annealing process or the like is performed to set the phase difference amount Re due to the birefringence of each lens so as to satisfy inequality (2) described in the first embodiment. In this embodiment, the phase difference amount Re of the first lens 205 is 18 nm, and the phase difference amount Re of the second lens 204 is 7 nm, each of which satisfies inequality (2).

### Adhesive Layer

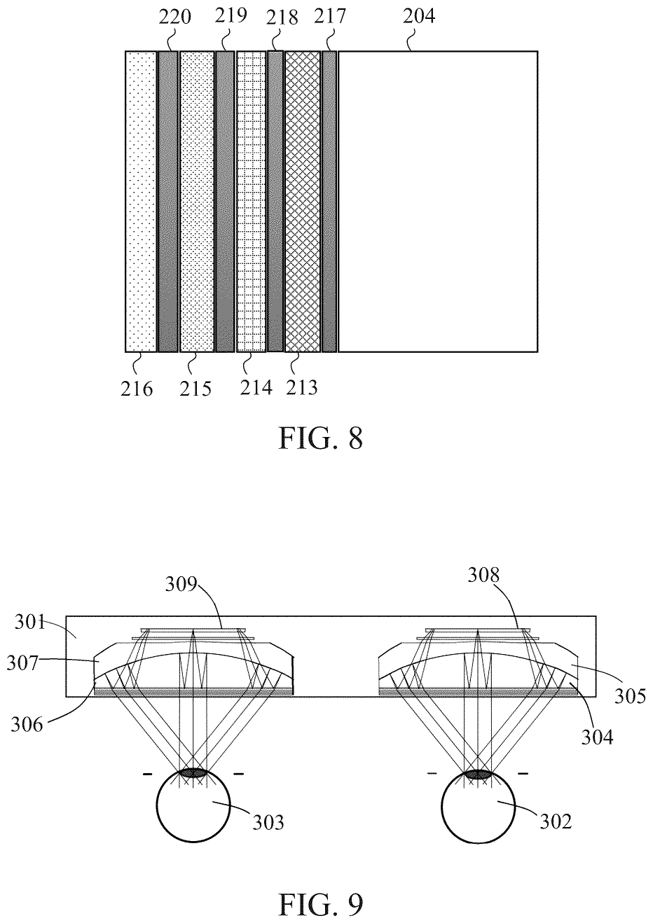

FIG. 8 illustrates an enlarged view of adhesive layers 218 to 220 in the optical unit and an adhesive layer 217 between the optical unit and the second lens 204. The second phase plate 213 and PBS 214 are adhered together via the adhesive layer 218, and the PBS 214 and second polarizing plate 215 are adhered together via the adhesive layer 219. In order to reduce reflection at the interface between the second polarizing plate 215 and air, an antireflection film 216 is adhered to the second polarizing plate 215 via the adhesive layer 220. The optical unit having such a laminated structure is adhered to the second lens 204 by the adhesive layer (first adhesive layer) 217.

The adhesive layer 217 may satisfy inequalities (3) and (4) described in the first embodiment, where d1 is a thickness of the adhesive layer 217, N1 is a refractive index of the second lens 204 for the d-line, and N2 is a refractive index of the adhesive layer 217 for the d-line. In this embodiment, the thickness d1 of the adhesive layer 217 is 0.015 mm (±0.003 mm), the refractive index N1 of the second lens 204 is 1.54, and the refractive index of the adhesive layer 217 is 1.46. Therefore, N2×d1=0.022 and N1/N2=1.058, each of which satisfies inequalities (3) and (4).

The thickness d1 of the adhesive layer 217 may satisfy inequality (5) described in the first embodiment, where f is the focal length of the optical system. In this embodiment, the focal length f is 13 mm, the thickness d1 of the adhesive layer 217 is 0.015 mm (±0.003 mm), and d1/f=0.0012. Therefore, inequality (5) is satisfied.

In an optical system that folds the optical path utilizing polarization, the adhesive layer 217 significantly affects the optical performance because the light ray from the right-eye display element 208 toward the observation side transmits through the adhesive layer 217 three times. Therefore, satisfying inequalities (3) to (5) can effectively suppress the deterioration of the quality of the displayed image caused by the cemented portion where the optical unit and the second lens 204 are adhered together via the adhesive layer 217.

The adhesive layers 218 to 220 in the optical unit will be described. Inequality (6) may be satisfied as in the first embodiment, where d2 is a thickness of the adhesive layer 218 that adheres the second phase plate 213 and the PBS 214. In this embodiment, the thickness d2 of the adhesive layer 218 is 0.015 mm (±0.003 mm), which satisfies inequality (6).

In this embodiment, the thickness of the adhesive layer 219 that adheres the PBS 214 and the second polarizing plate 215 is 0.020 mm (±0.003 mm), and the thickness of the adhesive layer 220 that adheres the second polarizing plate 215 and the antireflection film 216 is 0.025 mm (±0.003 mm). Thereby, the influence of the unevenness of each adhesive layer on the optical performance can be suppressed.

### Third Embodiment

### Image Display Apparatus

FIG. 9 illustrates an HMD 301 as an image display apparatus using an optical system according to a third embodiment, viewed from above. Reference numeral 302 denotes the observer's right eye, and reference numeral 303 denotes the observer's left eye. Lenses 304 and 305 form part of the right-eye optical system, and lenses 306 and 307 form part of the left-eye optical system. Reference numeral 308 denotes a right-eye display element, and reference numeral 309 denotes a left-eye display element, each of which includes an organic EL element that emits unpolarized light.

The right-eye optical system enlarges the light (virtual image) from the original image displayed on the right-eye display element 308 and guides it to the right eye 302, while the left-eye optical system enlarges the light from the original image displayed on the left-eye display element 309 and guides it to the left eye 303.

Each of the right-eye optical system and the left-eye optical system has a focal length f of 16 mm, a horizontal display angle of view of 65°, a vertical display angle of view of 65°, and a diagonal display angle of view 2×θ1 of 84°. A distance between the HMD 301 and the observer's eyeball (eye relief) is 20 mm.

### Optical System

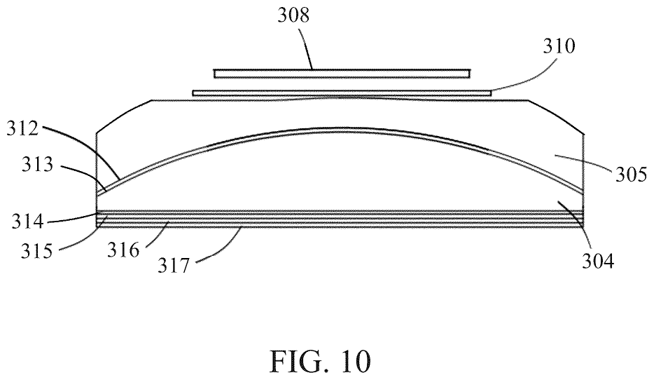

The optical system according to the third embodiment is also an optical system that folds the optical path by utilizing polarization, and an enlarged view of the right-eye optical system is illustrated in FIG. 10. In addition to the lenses 304 and 305, the right-eye optical system further includes a first polarizing plate 310 disposed between the right-eye display element 308 and the first lens 305, and the right-eye optical system further includes a PBS 312 and a first phase plate 313, arranged in this order from the display element side between the first and second lenses 305 and 304. Each of the PBS 312 and the first phase plate 313 has a curved surface shape and they are laminated and adhered together to form a first optical unit. The PBS 312 functions as a polarization separation surface disposed between cemented surfaces of the first and second lenses 305 and 304. In other words, the first and second lenses 305 and 304 are configured as a cemented lens in which the half-mirror 314 is sandwiched between the cemented surfaces. The ratio of the transmittance and reflectance of the half-mirror 314 may be 50:50, but the ratio may be changed, as necessary.

Arranged in order from the display element side on the observation side of the second lens 304 are a half-mirror 314, a second phase plate 315, and a second polarizing plate 316 as film elements. Each of the half-mirror 314, the second phase plate 315, and the second polarizing plate 316 has a planar shape and they are laminated and adhered together to form a second optical unit. The half-mirror 314 functions as a transmissive reflective surface.

Each of the first phase plate 313 and the second phase plate 315 is a waveplate with a phase difference of λ/4 (quarter waveplate). The polarization direction of the polarized light that transmits through the first polarizing plate 310 and the slow axis of the first phase plate 313 are tilted by 45°, and the polarization direction of the polarized light that transmits through the first polarizing plate 310 and the slow axis of the second phase plate 315 are tilted by −45°. The polarization direction of the polarized light that transmits through the first polarizing plate 310 and the polarization direction of the polarized light that transmits through the PBS 312 are consistent with each other. The polarization direction of the polarized light that transmits through the second polarizing plate 316 and the polarization direction of the polarized light that transmits through the PBS 312 coincide with each other.

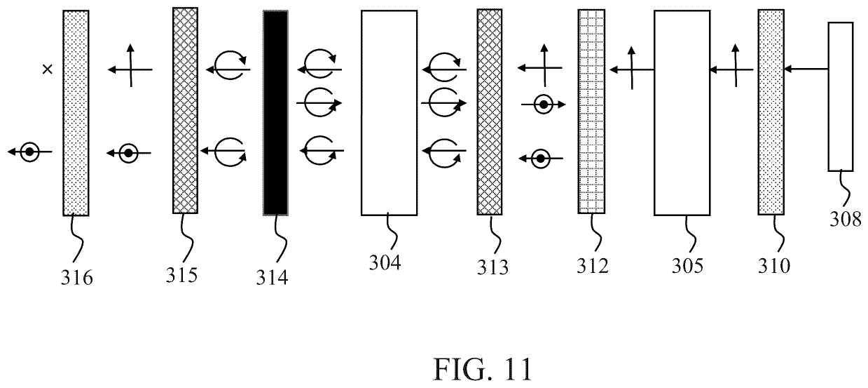

FIG. 11 illustrates the optical path of the right-eye optical system configured as described above. The nonpolarized light emitted from the right-eye display element 308 transmits through the first polarizing plate 310 and becomes linearly polarized light, and the linearly polarized light transmits through the first lens 305 and the PBS 312, transmits through the first phase plate 313, and becomes circularly polarized light. Part of the circularly polarized light that transmits through the second lens 304 is reflected by the half-mirror 314, and transmits through the second lens 304 and the first phase plate 313, and becomes linearly polarized light. Since the polarization direction of this linearly polarized light is orthogonal to the transmission polarization direction of the PBS 312, it is reflected by the PBS 312, transmits through the second lens 304, and transmits through the first phase plate 313, and becomes circularly polarized light. The circularly polarized light transmits through the first lens 305, transmits through the half-mirror 314, and transmits through the second phase plate 315, and becomes linearly polarized light. This linearly polarized light has a polarization direction that coincides with the transmission polarization direction of the second polarizing plate 316, and transmits through the second polarizing plate 316, and is guided to the right eye 302. The second polarizing plate 316 can reduce ghost light caused by external light, and increase the contrast of the displayed image. As for the left-eye optical system, the light from the left-eye display element 309 follows a similar optical path and is guided to the left eye 303.

An optical system that folds the optical path utilizing polarization in this way has a reduced thickness and a reduced focal length, and enables an image to be displayed at a wide angle of view. Forming the first and second lenses 305 and 304 into a cemented lens, placing the first optical unit between them, and further cementing the second optical unit to the second lens 304 can reduce the thickness of the optical system.

The HMD 301 is mounted on a user's head and thus may have a reduced weight. Thus, the lenses constituting the right-eye optical system can be manufactured using resin, which has a smaller specific gravity than that of glass, and all the lenses 304 and 305 are made of resin in the third embodiment. The second lens 304 is also a plano-convex aspherical lens to enhance the aberration correcting effect. The first lens 305 is also a double-sided aspherical lens. This is similarly applied to the left-eye optical system.

The characteristic configuration of the lenses according to this embodiment will be described. The right-eye optical system according to this example includes two lenses 304 and 305. The second lens 304 is a lens with positive refractive power, a flat lens surface on the observation side, and an aspheric lens surface on the display element side (the cemented portion surface with the first lens 305) that is convex toward the display element side. The PBS 312 is provided as a reflective surface on the display element side of the second lens 304, and the PBS 312 has positive refractive power, so that the optical path to be folded, and the optical system has a reduced thickness and a wide angle of view.

Since the display-element-side lens surface of the second lens 304 and the observation-side lens surface of the first lens 305 are cemented together to form a cemented surface, the total reflection condition for light incident on the cemented surface can be avoided compared to when these lens surfaces are in contact with air. The first lens 305 is a double-sided aspheric lens with negative refractive power.

Inequality (1) described in the first embodiment may be satisfied where Φ1 is the optical power on the optical axis of the first lens 305 and Φ2 is the optical power on the optical axis of the second lens 304. In this example, Φ1=−0.0075, Φ2=0.0112, and |Φ1/Φ2|=0.673. In other words, the optical system according to the third embodiment satisfies inequality (1).

The display-element-side surface of the first lens 305 has a convex shape toward the display element side in the central area including the optical axis, but the curvature becomes gentler as it moves away from the optical axis, and has an inflection point within an optically effective area, which is an area through which effective light ray that contribute to imaging passes.

Inequality (7) described in the second embodiment may be satisfied where Yip is a distance from the optical axis of the inflection point and Yea is a maximum distance from the optical axis (effective diameter) of the optically effective area of the display-element-side surface of the first lens 305. In this embodiment, Yip is 6 mm, Yea is 13 mm, Yip/Yea=0.46, and thus inequality (7) is satisfied.

The aspheric shape of the display element side of the first lens 305 changes monotonically as it moves away from the optical axis, and has no maximum or minimum values within the optically effective area other than a point on the optical axis. Such an aspheric shape can reduce the exit angle from the right-eye display element 308 at the peripheral portion and the focal length of the optical system. Reducing an aspheric shape change can reduce an optical performance change from the central portion to the peripheral portion, present a display image that is easy to observe, and improve the processing accuracy of the aspheric shape. The above description of the first lens 305 is also applicable to the first lens 307 in the left-eye optical system.

Even in this embodiment, the first and second lenses 305 and 304 are made of resin, and birefringence that occurs during molding of each lens may negatively affect the optical performance of the right-eye optical system. Therefore, an annealing process or the like is performed to set the phase difference amount Re due to the birefringence of each lens so as to satisfy inequality (2) described in the first embodiment. In this embodiment, the phase difference amount Re of the first lens 305 is 20 nm, and the phase difference amount Re of the second lens 304 is 5 nm, each of which satisfies inequality (2).

### Adhesive Layer

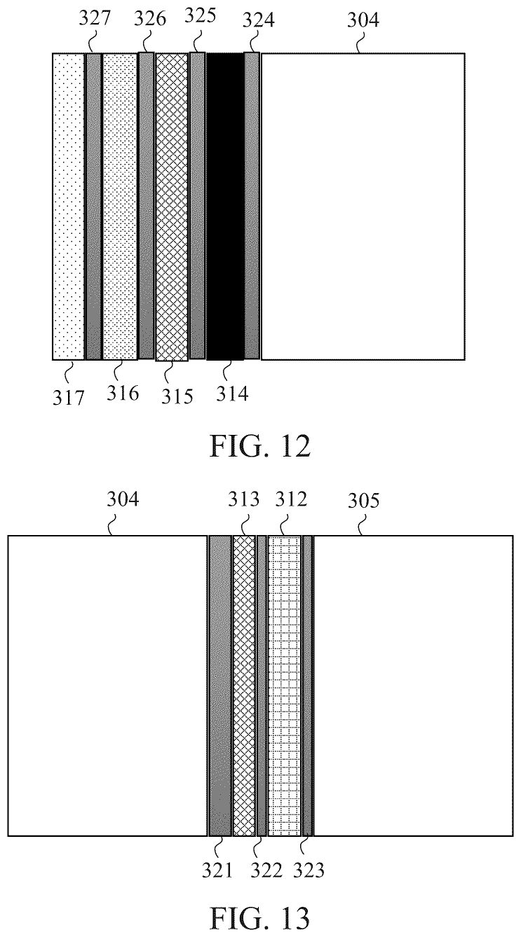

FIG. 12 illustrates an enlarged view of adhesive layers 325 to 327 in the second optical unit and an adhesive layer 324 between the second optical unit and the second lens 304. The half-mirror 314 and the second phase plate 315 are adhered together via the adhesive layer 325, and the second phase plate 315 and the second polarizing plate 316 are adhered together via the adhesive layer 326. In order to reduce reflection at the interface between the second polarizing plate 316 and air, an antireflection film 317 is adhered to the second polarizing plate 316 via the adhesive layer 327. The second optical unit having such a laminated structure is adhered to the lens 304 by the adhesive layer (first adhesive layer) 324.

The adhesive layer 324 may satisfy inequalities (3) and (4) described in the first embodiment, where d1 is a thickness of the adhesive layer 324, N1 is a refractive index of the second lens 304 for the d-line, and N2 is a refractive index of the adhesive layer 324 for the d-line. In this embodiment, the thickness d1 of the adhesive layer 324 is 0.020 mm (±0.003 mm), the refractive index N1 of the second lens 304 is 1.49, and the refractive index of the adhesive layer 324 is 1.478. Therefore, N2×d1=0.029 and N1/N2=1.006, which respectively satisfy inequalities (3) and (4).

The thickness d1 of the adhesive layer 324 may satisfy inequality (5) described in the first embodiment, where f is the focal length of the optical system. In this embodiment, the focal length f is 16 mm, the thickness d1 of the adhesive layer 324 is 0.020 mm (±0.003 mm), and d1/f=0.0013. Therefore, inequality (5) is satisfied.

FIG. 13 also illustrates an enlarged view of an adhesive layer 322 within the first optical unit, and adhesive layers 321 and 323 between the first optical unit and the lenses 304 and 305. The PBS 312 and first phase plate 313 are adhered together via the adhesive layer 322, the first phase plate 313 is adhered to second lens 304 via the adhesive layer (first adhesive layer) 321, and the PBS 312 is adhered to the first lens 305 via the adhesive layer 323.

Inequalities (3) and (4) described in the first embodiment may be satisfied, where d1 is a thickness of adhesive layer 321, N1 is a refractive index of the second lens 304 for the d-line, and N2 is a refractive index of the adhesive layer 321 for the d-line. In this embodiment, the thickness d1 of the adhesive layer 324 is 0.015 mm (±0.003 mm), the refractive index N1 of the lens 304 is 1.49, and the refractive index of the adhesive layer 321 is 1.46. Therefore, N2×d1=0.022 and N1/N2=1.018, which satisfy inequalities (3) and (4), respectively.

The thickness d1 of the adhesive layer 321 may satisfy inequality (5) described in the first embodiment, where f is a focal length of the optical system. In this embodiment, the focal length f is 16 mm, the thickness d1 of the adhesive layer 321 is 0.015 mm (±0.003 mm), and d1/f=0.0009. Therefore, inequality (5) is satisfied.

In an optical system that folds the optical path utilizing polarization, the adhesive layers 321 and 324 significantly affect the optical performance because the light ray from the right-eye display element 308 toward the observation side passes through the adhesive layers 321 and 324 at least three times. Therefore, satisfying inequalities (3) to (5) can effectively suppress the degradation of the quality of the displayed image caused by the cemented portions where the optical units and the lenses are adhered together via the adhesive layers 321 and 324.

The adhesive layers 325 to 327 in the first and second optical units will be described. d2 is each of the thickness of the adhesive layer 322 that adheres the PBS 312 and the first phase plate 313, the thickness of the adhesive layer 325 that adheres the half-mirror 314 and the second phase plate 315, and the thickness of the adhesive layer 326 that adheres the second phase plate 315 and the second polarizing plate 316. Then, inequality (6) may be satisfied as in the first embodiment. In this embodiment, the thickness of adhesive layer 322 is 0.010 mm (±0.003 mm), and the thickness of adhesive layer 325 is 0.015 mm (±0.003 mm), both of which satisfy inequality (6).

In this embodiment, the thickness of adhesive layer 326 is 0.015 mm (±0.003 mm), and the thickness of adhesive layer 327 that adheres the second polarizing plate 316 and the antireflection film 317 is 0.015 mm (±0.003 mm). This reduces the influence of unevenness in each adhesive layer on the optical performance.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can reduce image degradation of a displayed image caused by an adhesive layer that adheres an optical unit and a lens.

This application claims priority to Japanese Patent Application No. 2024-019913, which was filed on Feb. 14, 2024, and which is hereby incorporated by reference herein in its entirety.

What is claimed is:

1. An optical system configured to guide light from a display element to an observation side, the optical system comprising:
a transmissive reflective surface;
a polarization separation surface;
a polarizing element; and
a lens including a resin material,
wherein the transmissive reflective surface or the polarization separation surface and the polarizing element are integrated with each other to form an optical unit,
wherein the optical unit and the lens are cemented to each other via a first adhesive layer,
wherein the light transmits through the first adhesive layer a plurality of times, and
wherein the following inequalities are satisfied:
$$0.009 < N 2 \times d 1 < 0.031$$
$$0.95 \leq N 1 / N 2 \leq 1.1$$
where d1 (mm) is a thickness of the first adhesive layer, N1 is a refractive index of the lens for d-line, and N2 is a refractive index of the first adhesive layer for the d-line.

2. The optical system according to claim 1, wherein the following inequality is satisfied:
Re≤30
where Re (nm) a phase difference amount caused by birefringence of the lens.

3. The optical system according to claim 1, wherein the following inequality is satisfied:
$$0.0002 \leq d 1 / f \leq 0.002$$
where f is a focal length of the optical system.

4. The optical system according to claim 1, wherein the light transmits through the first adhesive layer three times.

5. The optical system according to claim 1, wherein at least one of the transmissive reflective surface and the polarization separation surface includes a film element, and the film element is attached to one of a plurality of polarizing elements via a second adhesive layer, and
wherein the following inequality is satisfied:
$$0.005 \leq d 2 < 0.02$$
where d2 (mm) is a thickness of the second adhesive layer.

6. The optical system according to claim 1, further comprising a first lens on a display element side and a second lens on the observation side, each of which is a resin lens, the first lens and the second lens being cemented together, and the transmissive reflective surface being disposed at a cemented portion between the first lens and the second lens,
wherein the optical unit including the polarization separation surface is adhered to an observation-side-surface of the second lens via the first adhesive layer.

7. The optical system according to claim 1, further comprising a first lens on a display element side and a second lens on the observation side, each of which is a resin lens, the first lens and the second lens being cemented together, and a first optical unit including the polarization separation surface being adhered to a cemented surface of the second lens with the first lens via the first adhesive layer,
wherein a second optical unit including the transmissive reflective surface is adhered to an observation-side surface of the second lens via the first adhesive layer.

8. The optical system according to claim 1, wherein a lens surface closest to a display element in the optical system is an aspheric surface that has a convex shape toward a display element side in a central area including an optical axis of the optical system, and an inflection point within an optically effective area.

9. The optical system according to claim 8, wherein the following inequality is satisfied:
$$0.2 \leq Yip / Yea \leq 0.75$$
where Yip is a distance from the optical axis to the inflection point on the aspheric surface, and Yea is a maximum distance from the optical axis to the optically effective area.

10. The optical system according to claim 1, further comprising a first lens on a display element side and a second lens on the observation side, each of which is a resin lens, the first lens and the second lens being cemented together, and the transmissive reflective surface or the polarization separation surface being disposed at a cemented portion between the first lens and the second lens,
wherein the following inequalities are satisfied:
$$0.2 \leq \vert Φ1 / Φ2 \vert \leq 0.8$$
where Φ1 is optical power on an optical axis of the optical system, of the first lens, and Φ2 is optical power on the optical axis of the second lens.

11. The optical system according to claim 1, further comprising a first lens on a display element side and a second lens on the observation side, each of which is a resin lens, the first lens and the second lens being cemented together, and the transmissive reflective surface or the polarization separation surface being adhered to a cemented surface of the second lens with the first lens via an adhesive layer,
wherein an observation-side-surface of the second lens is a planar surface, and
wherein the cemented surface is an aspheric surface that is convex toward a display element side.

12. The optical system according to claim 1, comprising, in order from a display element side to the observation side:
a first polarizing plate;
a first phase plate;
a first lens with negative refractive power;
the transmissive reflective surface;
a second lens with positive refractive power;
a second phase plate;
the polarization separation surface;
a second polarizing plate; and
a third lens with positive refractive power,
wherein the second phase plate is adhered to the second lens via the first adhesive layer.

13. The optical system according to claim 1, comprising, in order from a display element side to the observation side:
a first polarizing plate;
a first phase plate;
a first lens with negative refractive power;
the transmissive reflective surface;
a second lens with positive refractive power;
a second phase plate;
the polarization separation surface; and
a second polarizing plate,
wherein the second phase plate is adhered to the second lens via the first adhesive layer.

14. The optical system according to claim 1, comprising, in order from a display element side to the observation side:
a first polarizing plate;
a first lens with negative refractive power;
the polarization separation surface;
a first phase plate;
a second lens with positive refractive power;
the transmissive reflective surface;
a second phase plate; and
a second polarizing plate,
wherein the first phase plate is adhered to a display-element-side surface of the second lens via the first adhesive layer, and the transmissive reflective surface is adhered to an observation-side-surface of the second lens via the first adhesive layer.

15. An image display apparatus comprising:
an optical system configured to guide light from a display element to an observation side; and
the display element,
wherein the optical system includes:
a transmissive reflective surface;
a polarization separation surface;
a polarizing element; and
a lens including a resin material,
wherein the transmissive reflective surface or the polarization separation surface and the polarizing element are integrated with each other to form an optical unit,
wherein the optical unit and the lens are cemented to each other via a first adhesive layer,
wherein the light transmits through the first adhesive layer a plurality of times, and
wherein the following inequalities are satisfied:
$$0.009 < N 2 \times d 1 < 0.031$$
$$0.95 \leq N 1 / N 2 \leq 1.1$$
where d1 (mm) is a thickness of the first adhesive layer, N1 is a refractive index of the lens for d-line, and N2 is a refractive index of the first adhesive layer for the d-line.
